(19) United States
(12) Patent Application Publication
(10) Pub. No.: US 2025/0336102 A1
(43) Pub. Date: Oct. 30, 2025

(54) METHOD, APPARATUS, DEVICE, MEDIUM AND PRODUCT FOR IMAGE GENERATION

(71) Applicant: Beijing Youzhuju Network Technology Co., Ltd., Beijing (CN)

(72) Inventors: Yi Jiang, Beijing (CN); Shoufa Chen, Beijing (CN); Peize Sun, Beijing (CN); Yuqi Zhang, Beijing (CN); Shilong Zhang, Beijing (CN); Zehuan Yuan, Beijing (CN)

(21) Appl. No.: 19/193,830

(22) Filed: Apr. 29, 2025

(30) Foreign Application Priority Data
Apr. 30, 2024 (CN) 202410538229.4

(51) Int. Cl. G06T 11/00; G06N 3/08

(52) U.S. Cl. CPC G06T 11/00; G06N 3/08

(57) ABSTRACT

According to embodiments of the disclosure, a method, apparatus, a device, a medium, and a product for image generation are provided. The method includes: receiving a text sequence indicating condition information of image generation; inputting the text sequence into a trained image generation model; and generating, through the image generation model, a target image matching the condition information based on at least the text sequence. The target resolution of the target image is determined based on the text sequence. The image generation model is obtained through training based on a sample image set and a sample text sequence set. A sample image in the sample image set matches a sample text sequence in the sample text sequence set. Sample images in the sample image set have different resolutions, and sample text sequences have different text lengths.

### CROSS REFERENCE

The present application claims priority to Chinese Patent Application No. 202410538229.4, filed on Apr. 30, 2024 and entitled “METHOD, APPARATUS, DEVICE, MEDIUM AND PRODUCT FOR IMAGE GENERATION”, the entirety of which is incorporated herein by reference.

### FIELD

Example embodiments of the present disclosure generally relate to the field of computer technologies, and in particular, to a method, apparatus, a device, a computer-readable storage medium, and a computer program product for image generation.

### BACKGROUND

Text-to-image generation (T2I) is an important research direction in the field of image generation, and usually refers to a task of generating a visual image by using a computer algorithm in computer vision. This task requires that an algorithm can generate a new image based on a specific input (such as a text description, another image, or noise data). The purpose is to apply an image generation technology to restore a semantic relationship described in a text and to generate a semantically-related image. A challenge in this type of task is to make the generated image realistic, accurate, and diverse, that is, the image should match specified input information, and should be visually convincing and diverse. The text-to-image generation task is widely used in the fields of artistic creation, game design, model visual effect test, simulation training, and the like.

### SUMMARY

In a first aspect of the present disclosure, a method for image generation is provided. The method includes: receiving a text sequence indicating condition information of image generation; inputting the text sequence into a trained image generation model; and generating, through the image generation model, a target image matching the condition information based on at least the text sequence. A target resolution of the target image is determined based on the text sequence. The image generation model is obtained through training based on a sample image set and a sample text sequence set. A sample image in the sample image set matches a sample text sequence in the sample text sequence set. Sample images in the sample image set have different resolutions, and sample text sequences have different text lengths.

In a second aspect of the present disclosure, an apparatus for image generation is provided. The apparatus includes: a text receiving module configured to receive a text sequence indicating condition information of image generation; a text inputting module configured to input the text sequence into a trained image generation model; and an image generating module configured to generate, through the image generation model, a target image matching the condition information based on at least the text sequence. A target resolution of the target image is determined based on the text sequence. The image generation model is obtained through training based on a sample image set and a sample text sequence set. A sample image in the sample image set matches a sample text sequence in the sample text sequence set. Sample images in the sample image set have different resolutions, and sample text sequences have different text lengths.

In a third aspect of the present disclosure, an electronic device is provided. The device includes: at least one processing unit; and at least one memory. The at least one memory is coupled to the at least one processing unit and stores instructions executable by the at least one processing unit. The instructions, when executed by the at least one processing unit, cause the device to perform the method in the first aspect.

In a fourth aspect of the present disclosure, a computer-readable storage medium is provided. A computer program is stored on the medium. The computer program, when executed by a processor, implements the method in the first aspect.

In a fifth aspect of the present disclosure, a computer program product is provided. The computer program product includes a computer program. The computer program, when executed by a processor, implements the method in the first aspect.

It should be understood that, content described in this part is not intended to limit key features or important features of the embodiments of the present disclosure, nor is it intended to limit the scope of the present disclosure. Other features of the present disclosure will become readily comprehensible through the following description.

### BRIEF DESCRIPTION OF THE DRAWINGS

The above and other features, advantages, and aspects of embodiments of the present disclosure become more apparent with reference to the following detailed description and in conjunction with the drawings. The same or similar reference numerals in the drawings denote the same or similar elements, where:

FIG. 1 is a schematic diagram of an example environment in which embodiments of the present disclosure can be implemented;

FIG. 2 is a schematic diagram of an architecture of an image generation model according to some embodiments of the present disclosure;

FIG. 3 is a schematic diagram of an image generation model based on a diffusion model according to some embodiments of the present disclosure;

FIG. 4 is a schematic diagram of a training process of an image generation model according to some embodiments of the present disclosure;

FIG. 5 is a schematic diagram of an environment in which embodiments of the present disclosure can be implemented;

FIG. 6 is a schematic diagram of a process for image generation according to some embodiments of the present disclosure;

FIG. 7 is a block diagram of an apparatus for image generation according to some embodiments of the present disclosure; and

FIG. 8 is a block diagram of an electronic device in which one or more embodiments of the present disclosure can be implemented.

### DETAILED DESCRIPTION

Embodiments of the present disclosure are described in more detail below with reference to the drawings. Although some embodiments of the present disclosure are shown in the drawings, it should be understood that the present disclosure may be implemented in various forms and should not be construed as limited to the embodiments set forth herein. Rather, these embodiments are provided for a more thorough and complete understanding of the present disclosure. It should be understood that the drawings and the embodiments of the present disclosure are only for illustrative purposes and are not intended to limit the scope of protection of the present disclosure.

In the description of the embodiments of the present disclosure, the term “include/include” and similar terms should be understood as open inclusion, that is, “include/include but not limited to”. The term “be based on” should be understood as “be at least partially based on”. The term “an embodiment” or “the embodiment” should be understood as “at least one embodiment”. The term “some embodiments” should be understood as “at least some embodiments”. Other explicit and implicit definitions may be included below.

It can be understood that data involved in the technical solution of the present disclosure (including but not limited to the data itself, the acquisition or use of the data) should comply with requirements of corresponding laws and regulations and related provisions.

It can be understood that before using the technical solutions disclosed in the embodiments of the present disclosure, a user should be informed of a type, a usage scope, a usage scene, or the like of personal information involved in the present disclosure and grant authorization in an appropriate manner in accordance with relevant laws and regulations.

For example, in response to receiving an active request from the user, prompt information is sent to the user, to clearly prompt the user that an operation requested by the user will require the acquisition and use of the personal information of the user, so that the user can independently choose whether to provide the personal information to software or hardware, such as an electronic device, an application, a server, or a storage medium, that performs the operation of the technical solution of the present disclosure, based on the prompt information.

As an optional but non-limiting implementation, a manner of sending the prompt information to the user in response to receiving the active request from the user may be, for example, a pop-up window, and the prompt information may be presented in text in the pop-up window. In addition, the pop-up window may further include a selection control for the user to choose whether to “agree” or “disagree” to provide the personal information to the electronic device.

It can be understood that the above process of notifying and obtaining user authorization is only illustrative and does not constitute a limitation on implementations of the present disclosure. Other manners that meet the requirements of relevant laws and regulations may also be applied to the implementations of the present disclosure.

As used herein, the term “model” may learn an association relationship between a corresponding input and output from training data, so that after the training is completed, a corresponding output may be generated for a given input. The generation of the model is based on a machine learning technology. Deep learning is a machine learning algorithm that processes an input and provides a corresponding output by using a plurality of processing units. A neural network model is an example of a model based on deep learning. In this specification, “model” may also be referred to as “machine learning model”, “learning model”, “machine learning network”, or “learning network”, and these terms are interchangeably used in this specification.

A “neural network” is a machine learning network based on deep learning. The neural network can process an input and provide a corresponding output, and usually includes an input layer, an output layer, and one or more hidden layers between the input layer and the output layer. The neural network used in the deep learning application usually includes many hidden layers, thereby increasing the depth of the network. Layers of the neural network are sequentially connected, so that the output of the previous layer is provided as the input of the next layer, where the input layer receives the input of the neural network, and the output of the output layer is the final output of the neural network. Each layer of the neural network includes one or more nodes (also referred to as processing nodes or neurons), and each node processes the input from the previous layer.

Usually, machine learning may generally include three stages, namely, a training stage, a test stage, and an application stage (also referred to as an inference stage). In the training stage, a given model may be trained using a large amount of training data, and parameter values are iteratively updated until the model can obtain a consistent inference that meets an expected target from the training data. Through training, the model may be considered capable of learning an association (also referred to as an input-to-output mapping) from input to output from the training data. The parameter values of the trained model are determined. In the test stage, the test input is applied to the trained model to test whether the model can provide a correct output, so as to determine the performance of the model. The test stage may sometimes be incorporated into the training stage. In the application or inference stage, the trained model may be used to process an actual model input based on the obtained parameter values, to determine a corresponding model output.

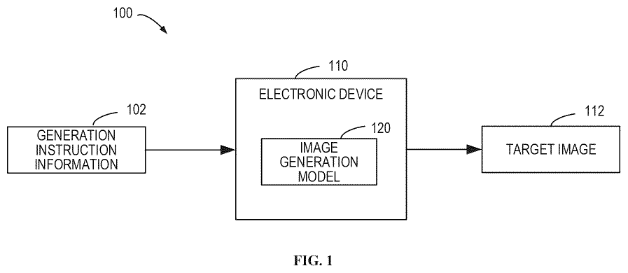

FIG. 1 is a schematic diagram of an example environment 100 in which embodiments of the present disclosure can be implemented. In the environment 100, the electronic device 110 may perform an image generation task by using an image generation model 120. In some implementations, the electronic device 110 may generate a target image 112 through the image generation model 120 based on the generation instruction information 102. In the text-to-image generation scenario, the generation instruction information 102 includes at least a text sequence. The text sequence may be entered by the user in a natural language, to indicate a desired image generation target.

In FIG. 1, the electronic device 110 may be any type of device with a computing capability, including a terminal device or a server-side device. The terminal device may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a positioning device, a television receiver, a radio broadcast receiver, an e-book device, a game device, or any combination thereof, including accessories and peripherals of these devices, or any combination thereof. The server-side device may include, for example, a computing system/server, such as a mainframe, an edge computing node, a computing device in a cloud environment, and the like.

It should be understood that the structure and function of the environment 100 are described for illustrative purposes only, without suggesting any limitation to the scope of the present disclosure.

Current text-to-image (T2I) models are trained on large-scale image-text pairs, showing the ability to generate high-quality images under the guidance of text prompts provided by users. Based on these pre-trained T2I models, personalized generation and conditional generation provide finer-grained control over the generated images. In the field of deep learning, generative adversarial networks and variational autoencoders are mainstream technical frameworks in the field of text-to-image generation. However, in the current image generation process, the model input may be specified to process the text input with a fixed text length. When the length of the text sequence provided by the user is insufficient or exceeds the fixed text length, the input text sequence will be processed by supplementing padding information or cutting off an extra length. In addition, the images output by these models all have a predetermined resolution. Such a fixed text length and a fixed resolution limit specific applications of image generation.

According to solutions of the present disclosure, an improved image generation solution is proposed, which supports image generation of any text length and any resolution. The image generation model is obtained by training based on a sample image set and a sample text sequence set. A sample image in the sample image set matches a sample text sequence in the sample text sequence set. Sample images in the sample image set have different resolutions, and sample text sequences have different text lengths. In this way, the image generation model has an understanding of any text length and generates an image with any resolution. After the input text sequence is received, the text sequence does not need to be padded or cropped. The image generation model may determine the resolution of the to-be-generated image based on an indication of the input text sequence, and generate a target image matching the text sequence.

The text-to-image solution of any resolution and any text sequence proposed in embodiments of the present disclosure enables the generation of images of any resolution and supports prompt text input of any length. This technology makes it possible to apply the text-to-image algorithm in actual scenarios.

Some example embodiments of the present disclosure are described below with reference to the drawings.

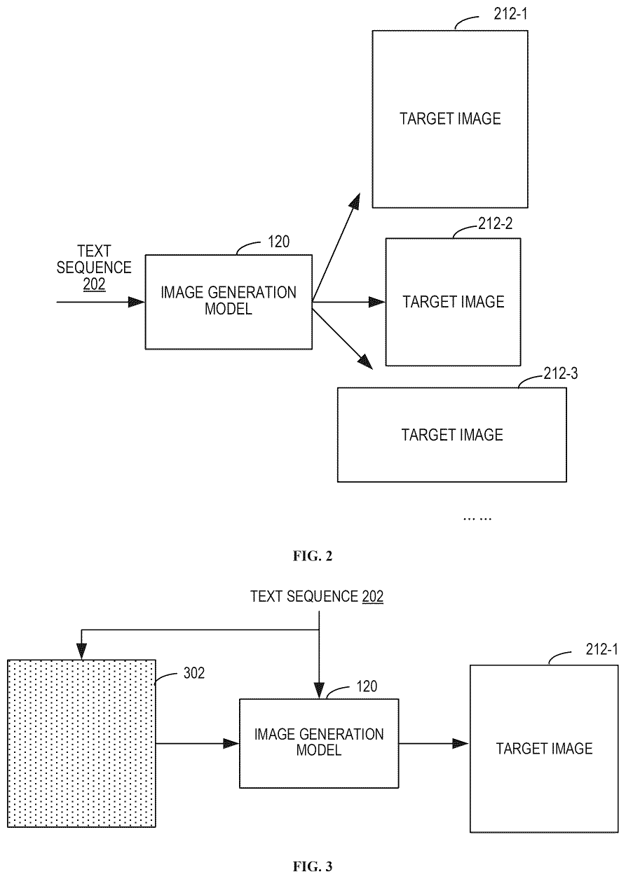

FIG. 2 is a schematic diagram of an architecture 200 of an image generation model according to some embodiments of the present disclosure. For ease of understanding, the image generation model is described with reference to the environment 100 in FIG. 1.

In FIG. 2, it is assumed that the image generation model 120 has been trained. The training process of the image generation model 120 is described in more detail below.

As shown in FIG. 2, to enable the image generation model 120 to generate an image, input information for the trained image generation model 120 needs to be obtained. The input information includes at least a text sequence 202 of the to-be-generated image, which describes condition information to be satisfied for the image generation. For example, if the user expects to generate an image of a puppy, the text sequence 202 may indicate “a puppy”. Certainly, the text sequence 202 may include more complex condition information for constraining image generation.

The text sequence 202 may be entered by the user, or may be specified by the user in any other appropriate way. The text sequence 202 may include text elements expressed in a natural language.

Different from the case where the input text sequence needs to be pre-processed to modify the text sequence to a predetermined text length by padding or cropping, in the embodiments of the present disclosure, the received text sequence 202 is input into the trained image generation model 120, without transforming the text sequence 202 to a predetermined text length. In some embodiments, the image generation model 120 includes a text encoder configured to encode the input text sequence into a feature vector that can be processed by the model. The image generation model 120 is trained to lift a maximum length restriction of the text encoder, so that the image encoding of any text length can be supported.

Next, the image generation model 120 generates a target image matching the condition information based on at least the text sequence 202. The resolution of the image generated by the image generation model 120 is not fixed, but determined based on the text sequence 202. As shown in FIG. 2, depending on the text sequence 202, the generated target image may be a target image 212-1, 212-2, 212-3, etc. (collectively or individually referred to as the target image 212), which have different resolutions (with different length-to-height ratios and different pixel values for the individual length and the individual height).

In the embodiments of the present disclosure, the image generation model 120 is obtained by training based on a sample image set and a sample text sequence set. A sample image in the sample image set matches a sample text sequence in the sample text sequence set. Sample images in the sample image set have different resolutions, and sample text sequences have different text lengths. In this way, the image generation model 120 may learn to understand a text sequence of any text length and generate an image of any resolution. The training process of the image generation model 120 is described in more detail below.

In some embodiments, the text sequence 202 further indicates the target resolution to be generated. In the image generation process, the target resolution may be determined from the text sequence 202 through the image generation model 120. Then, the image generation model 120 generates the target image according to the determined target resolution. For example, the text sequence 202 may include a requirement for the target resolution, that is, include a constraint condition for the resolution of the image. The text encoder in the image generation model 120 may also encode the resolution information, so that the image generation model 120 is required to generate the corresponding target image 212 according to the corresponding resolution. In some embodiments, if the text sequence 202 does not have a specific requirement for the target resolution to be generated, the image generation model 120 may generate the target image according to the default resolution or a random resolution.

In some embodiments, the image generation model 120 includes a diffusion probability model. For better understanding, the diffusion probability model is briefly introduced below.

The diffusion probability model (or referred to as diffusion model) is a type of generative model that generates N image chains with increasing noise by gradually adding Gaussian noise to the image, and then trains the model to predict the noise added to the image from one step to the next step. The data generation process of the diffusion model is based on a pair of Markov processes, i.e., a forward diffusion process and a backward denoising process. The forward diffusion process of the diffusion model (expressed as:

$$q ( {x}^{( 1 : T )} \vert {x}^{( 0 )} ) = {\prod }_{t = 1}^{T} q ( {x}^{( t )} \vert {x}^{( t - 1 )} ) )$$

gradually disturbs data x⁽⁰⁾˜q(x⁽⁰⁾), and obtains a static noise distribution x^{(T)}˜qₙₒᵢₛₑ through T gradual noise addition steps x^{(1:T)}=x₁, . . . , x^{(t-1)}, x^{(t)}, . . . , x^{(T)}. Through model training, the learned backward denoising process (expressed as:

$$p e ( {x}^{( 0 : T )} ) = p ( {x}^{( t )} ) {\prod }_{t = 1}^{T} {p}_{θ} ( {x}^{( t - 1 )} \vert {x}^{( t )} ) )$$

performs the opposite process, gradually denoises the sample toward the data distribution, to obtain data x⁽⁰⁾˜q(x⁽⁰⁾). It can be seen that the backward denoising process may correspond to a desired data modeling process, and the desired data is finally obtained.

In some implementations, to fit the model (expressed as: p_{θ}(x⁽⁰⁾) to the data distribution q(x⁽⁰⁾), the learning of the backward denoising process is usually implemented by optimizing a variational constraint for the log-likelihood, which may be expressed as follows:

$${q ( {x}^{( 0 )} )}_{} [ log {p}_{θ} ( {x}^{( 0 )} ) ] \geq {q}_{} ( {x}^{( 0 : T )} ) [ log \frac{{p}_{θ} ( {x}^{( 0 : T )} )}{q ( {x}^{( 1 : T )} \vert {x}^{( 0 )} )} ] = {q ( {x}^{( 0 )} )}_{} [ log {p}_{θ} ( {x}^{( 0 )} \vert {x}^{( 1 )} ) + const . {\sum }_{t = 2}^{T} {\underbrace{- KL [ q ( {x}^{( t - 1 )} \vert {x}^{( t )} , {x}^{( 0 )} ) ‖ {p}_{θ} ( {x}^{( t - 1 )} \vert {x}^{( t )} ) ] ]}}_{{𝒥}_{t}} \qquad ( 1 )$$

After the learning is completed, the model that performs the backward denoising process may first sample from the noise distribution qₙₒᵢₛₑ(x^{(T)}), and perform iterative denoising by using p_{θ}(x^{(t-1)}|x^{(t)}), until the desired data is obtained.

In the image generation process implemented based on the diffusion model, a noise image sampled from a noise distribution based on a text sequence may be used as part of the input of the image generation model 120. FIG. 3 is a schematic diagram of an image generation model based on a diffusion model according to some embodiments of the present disclosure. As shown in FIG. 3, a noise image 302 may be sampled from the noise distribution based on the text sequence 202. The noise image 302 may be a two-dimensional noise image, or a noise image in any other dimension. The resolution of the noise image 302 may correspond to the target resolution explicitly specified in the text sequence 202, or the noise image with the default resolution or the random resolution is sampled when the resolution is not explicitly specified in the text sequence 202. The resolution of the noise image 302 may be the same as the target resolution of the final target image (for example, the target image 212-1) to be generated. The image generation model 120 generates the target image 212-1 with the corresponding resolution according to the image generation process of the diffusion model. Therefore, the image generation of any resolution may be implemented based on the two-dimensional noise image by using the diffusion model.

Although the model structure based on the diffusion model is described above, in other embodiments, the image generation model 120 may also be based on other model structures suitable for image generation, such as a generative adversarial network, a variational autoencoder, an image generation model structure based on a language model, and the like. These model structures are all suitable for implementing the image generation of any text length and any resolution by applying the principles of the embodiments of the present disclosure.

In some embodiments, the image generation model 120 further includes an attention-based module. The model processing may be implemented through a self-attention mechanism to complete the image generation. In some embodiments, the attention-based module may include a Transformer block, for example, a Transformer block in an LLaMA model, which may increase the training stability, facilitate the increase of the model, and improve the processing accuracy.

In some embodiments, in terms of model structure, the position encoding required for the input of the Transformer block may be Rotary Position Embedding (RoPE), which is convenient for learning any resolution.

In the Transformer block, the essence of the attention mechanism is to calculate the attention weight of each token in the input sequence and the entire sequence. Assuming that qm and kn respectively represent that the feature vector q is located at the position m and the feature vector k is located at the position n, when no position information is added, qm=q, kn=k. When calculating the attention weight between the two, if the position information is not added, no matter how the positions of q and k change, the attention weight between them does not change, that is, the attention weight is independent of the position. However, for two feature vectors, if the distance between them is short, it is desired that the attention weight between them is greater, and when the distance is long, the attention weight is smaller. To solve this problem, it is necessary to introduce position encoding for the model, so that each feature vector can perceive the position information of it in the input sequence. We define the following function, which represents injecting the position information m into the word vector q to obtain qm, then the attention weight between qm and kn may be expressed as position-related. However, if the absolute position encoding is used, the model can only perceive the absolute position of each feature vector during training, but cannot perceive the relative position between two vectors. The ROPE position encoding assigns position information by rotating a vector by a certain angle. The ROPE position encoding is more suitable for learning any resolution.

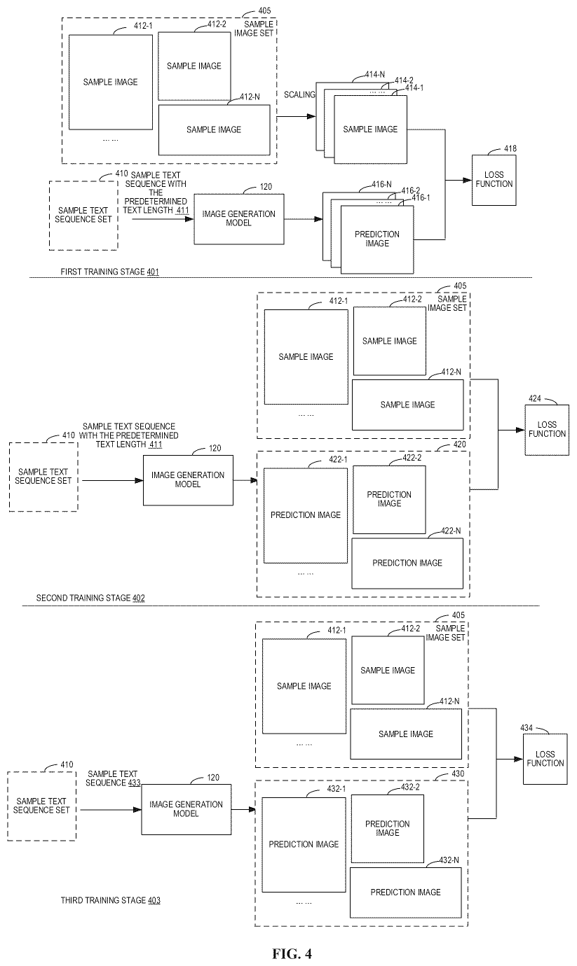

In some embodiments, the training process of the image generation model 120 may include a plurality of training stages. This training method includes a plurality of stages of image and text processing, and involves different transformation methods. FIG. 4 is a schematic diagram of a training process of the image generation model 120 according to some embodiments of the present disclosure. As shown in the figure, the training process includes three training stages, including a first training stage 401, a second training stage 402, and a third training stage 403.

The training data of the image generation model 120 includes a sample image set 405 and a sample text sequence set 410. The sample images 412-1, 412-2, . . . , 412-N (collectively or individually referred to as sample images 412) in the sample image set 405 have different resolutions, and each sample image 412 has a matching sample text sequence in the sample text sequence set 410. The matching of an image with a text sequence refers to that the text sequence and the image are semantically matched, and the text sequence accurately describes the visual content of the image. In addition, the text lengths of individual sample text sequences in the sample text sequence set 410 are also different.

In the first training stage 401 (an initial training stage), the respective sample images 412 in the sample image set 405 are transformed to a predetermined resolution, to generate a modified sample image set, including sample images 414-1, 414-2, . . . , 414-N (collectively or individually referred to as sample images 414). In some embodiments, the sample images 412 with different resolutions may be transformed to the sample images 414 with the same resolution in a scaling and cutting manner. In addition, the respective sample text sequences in the sample text sequence set 410 are padded or cropped to a predetermined text length, to generate a modified sample text sequence set, including respective sample text sequences 411 with a predetermined text length. For example, the sample text sequences 411 with the predetermined text length may be obtained by supplementing a mask of a predetermined value or cutting off an extra text length. The supplemented mask of the predetermined value is, for example, a meaningless numerical value such as 0 or 1.

The parameter value of the image generation model 120 is updated based on a sample image and a sample text sequence that match each other in the generated modified sample image set and the modified sample text sequence set. Specifically, in the first training stage 401, the respective sample text sequences 411 with the predetermined text length are input into the initialized image generation model 120. The initialized image generation model 120 processes the input sample text sequences 411 based on the current parameter value, to generate corresponding prediction images 416-1, 416-2, . . . , 416-N (collectively or individually referred to as the prediction image 416). In this training stage, the prediction image 416 is generated with the same predetermined resolution as the sample image 414. During the training, a difference between the individual prediction image 416 and the corresponding sample image 414 is determined to calculate a loss value of a loss function 418. Based on the size of the loss value, the parameter value of the image generation model 120 is iteratively updated by using stochastic gradient descent, until the difference between the prediction image 416 output by the image generation model 120 and the real sample image 414 is reduced, thereby reducing or minimizing the loss value of the loss function 418, and completing the training of the first training stage 401.

The generalization ability of the model can be improved in the first training stage. By using the transformation and cutting to unify the resolution of the image, the model can better adapt to different image sizes and shapes, and has better generalization ability when processing various images in the real world.

In the second training stage 402, the image generation model 120 is allowed to learn the learning of different image resolutions based on a dynamic bucket policy of the image resolution. Specifically, in the second training stage, the respective sample images 412 in the sample image set 405 are divided into a plurality of sample image subsets based on the respective resolution, and each sample image subset is associated with a corresponding resolution. Each sample image subset corresponds to a scale bucket for one resolution. Each sample image 412 may be allocated to a sample image subset corresponding to the closest resolution. When the image is allocated, the resolution of the sample image 412 may be not changed or minimally changed.

In the second training stage 402, for the sample text sequence set 410, the respective sample text sequence therein is still padded or cropped to the predetermined text length, to generate a modified sample text sequence set. The modified sample text sequence set includes the respective sample text sequences 411 with the predetermined text length. For example, the sample text sequence 411 with the predetermined text length may be obtained by supplementing the mask of the predetermined value or cutting off the extra text length. The supplemented mask of the predetermined value is, for example, a meaningless numerical value such as 0 or 1. Then, the parameter value of the image generation model 120 is trained based on the plurality of sample image subsets corresponding to the different resolutions and the modified sample text sequence set.

Specifically, in each of a plurality of training batches in the second training stage 402, the parameter value of the image generation model 120 is updated based on one of the plurality of sample image subsets and sample text sequences 411 matching the one sample image subset in the modified sample text sequence set. For example, in each training batch, one sample image subset is randomly selected from the plurality of sample image subsets according to the resolution. The respective sample text sequences 411 with the predetermined text length corresponding to the selected sample image subset are input into the image generation model 120. The image generation model 120 updated in the first training stage 401 processes the input sample text sequence 411 based on the current parameter value, to generate corresponding prediction images 422-1, 422-2, . . . , 422-N (collectively or individually referred to as the prediction image 422). In this training stage, the prediction image 422 is generated as a prediction image with any resolution. During the training, a difference between the individual prediction image 422 and the corresponding sample image 412 is determined to calculate a loss value of a loss function 424. Based on the size of the loss value, the parameter value of the image generation model 120 is iteratively updated by using stochastic gradient descent, until the difference between the prediction image 422 output by the image generation model 120 and the real sample image 412 is reduced, thereby reducing or minimizing the loss value of the loss function 424, and completing the training of the second training stage 402. The calculation of the stochastic gradient and the update of the parameter value are based on training batches, and therefore, in each training batch, the gradient is calculated and the model parameter value is updated according to the sample image subset corresponding to one resolution.

In the second training stage 402, the image generation model 120 may complete the learning of multiple scales/multiple resolutions. In the second training stage, the image is divided into multiple-scale buckets, and different image scales are randomly sampled for training, which increases the capability of the model to recognize images of various sizes and resolutions, and introduces randomness in the training process, thereby reducing the overfitting of the model to a specific resolution. In addition, in the first and second training stages, the text sequence reaches a fixed length by padding the mask and collecting, which allows the model to adapt to text of different lengths. This method enables the model to have a certain fault tolerance when facing a text input of an unexpected length, and enhances the robustness of the model.

In the third training stage 403, the image generation model 120 continues to be trained based on the plurality of sample image subsets divided by resolution in the sample image set 405 and the sample text sequence set 410 with any text length, to continue to update the parameter value of the image generation model 120.

In each of a plurality of training batches in the third training stage 403, the parameter value of the image generation model 120 is updated based on one of the plurality of sample image subsets and a sample text sequence 433 matching the one sample image subset in the sample text sequence set 410. For example, in each training batch, one sample image subset is randomly selected from the plurality of sample image subsets according to the resolution. The respective sample text sequence 433 with any text length corresponding to the selected sample image subset is input into the image generation model 120. The image generation model 120 updated in the second training stage 402 processes the input sample text sequence 433 based on the current parameter value, to generate a corresponding prediction image 432-1, 432-2, . . . , 432-N (collectively or individually referred to as the prediction image 432). In this training stage, the prediction image 432 is generated as a prediction image with any resolution. During the training, a difference between the individual prediction image 432 and the corresponding sample image 412 is determined to calculate a loss value of a loss function 434. Based on the size of the loss value, the parameter value of the image generation model 120 is iteratively updated by using stochastic gradient descent, until the difference between the prediction image 432 output by the image generation model 120 and the real sample image 412 is reduced, thereby reducing or minimizing the loss value of the loss function 434, and completing the training of the third training stage 403. The calculation of the stochastic gradient and the update of the parameter value are based on training batches, and therefore, in each training batch, the gradient is calculated and the model parameter value is updated according to the sample image subset corresponding to one resolution.

In the third training stage, no constraint is imposed on the text length, so that the model can process a text of any length, thereby improving the flexibility and extensibility. This flexibility is important because text data lengths in the real world often vary greatly.

After the above three stages of training, the trained image generation model can support the generation of any resolution and any length of text, making the model more suitable for real-world applications, because in real scenarios, the model is often required to process non-standardized data and generate more diverse images.

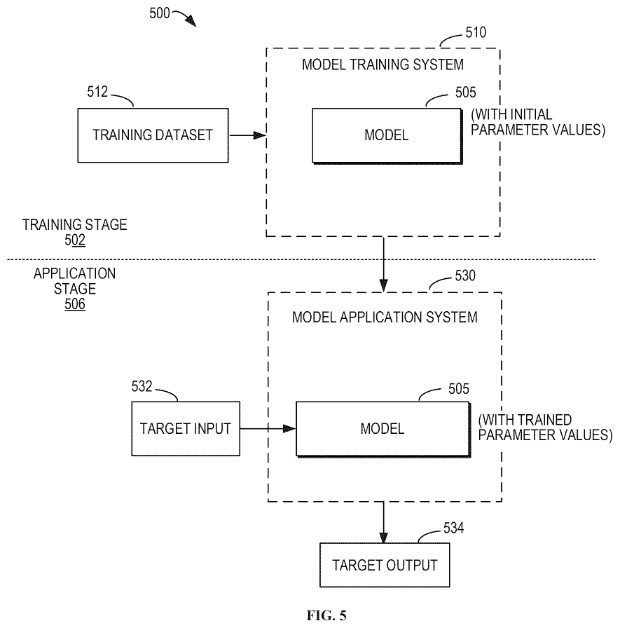

FIG. 5 is a schematic diagram of an environment 500 in which embodiments of the present disclosure can be implemented. In the environment 500 in FIG. 5, it is generally shown that the model involves different stages, including a training stage 502 and an application stage 506. There may also be a test stage after the training stage, which is not shown in the figure.

In the training stage 502, a model training system 510 is configured to train a model 505 using a training dataset 512. The model 505 may be, for example, the image generation model 120 in FIG. 1. At the start of the training, the model may have initial parameter values. The training process is to update the parameter values of the model 505 to desired values based on the training data. The model training system 510 may be configured to be implemented at the electronic device 110 in FIG. 1 or at another device/system.

In the application stage 506, the obtained model 505 has a trained parameter value and may be provided to a model application system 530 for use. In the application stage 506, the model 505 may be used to process a corresponding target input 532 in an actual scenario, and a corresponding target output 534 is provided. The model application system 530 may be configured to be implemented at the electronic device 110 in FIG. 1.

In FIG. 5, the model training system 510 and the model application system 530 may include any computing system with a computing capability, such as various computing devices/systems, terminal devices, servers, and the like. The terminal device may involve any type of mobile terminal, fixed terminal, or portable terminal, including a mobile phone, a desktop computer, a laptop computer, a notebook computer, a netbook computer, a tablet computer, a media computer, a multimedia tablet, or any combination thereof, including accessories and peripherals of these devices, or any combination thereof. The server includes but is not limited to a mainframe, an edge computing node, a computing device in a cloud environment, and the like.

It should be understood that the components and arrangements in the environment 500 shown in FIG. 5 are only examples, and the computing system suitable for implementing the example implementations described in the present disclosure may include one or more different components, other components, and/or different arrangements. For example, although shown as separate, the model training system 510 and the model application system 530 may be integrated into the same system or device, such as the electronic device 110 in FIG. 1. The implementations of the present disclosure are not limited in this respect.

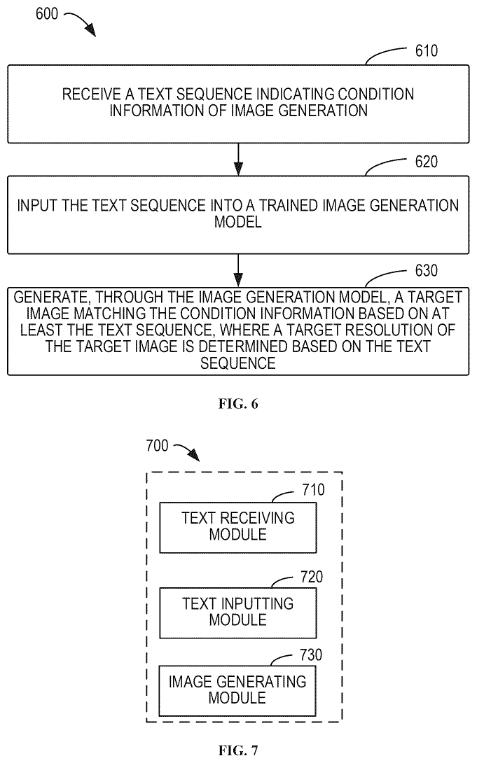

FIG. 6 is a schematic diagram of a process 600 for image generation according to some embodiments of the present disclosure. The process 600 may be implemented at the electronic device 110 in FIG. 1.

At block 610, the electronic device 110 receives a text sequence indicating condition information of image generation.

At block 620, the electronic device 110 inputs the text sequence into a trained image generation model.

At block 630, the electronic device 110 generates, through the image generation model, a target image matching the condition information based on at least the text sequence. The target resolution of the target image is determined based on the text sequence. The image generation model is obtained through training based on a sample image set and a sample text sequence set. A sample image in the sample image set matches a sample text sequence in the sample text sequence set. Sample images in the sample image set have different resolutions, and sample text sequences have different text lengths.

In some embodiments, the text sequence is input into the trained image generation model, without transforming the text sequence to a predetermined text length.

In some embodiments, the text sequence further indicates the target resolution to be generated, and generating, through the image generation model, the target image matching the condition information based on at least the text sequence includes: determining, through the image generation model, the target resolution from the text sequence; and generating, through the image generation model, the target image according to the determined target resolution.

In some embodiments, the training of the image generation model includes a first training stage, and the first training stage includes: generating, by transforming a respective sample image in the sample image set to a predetermined resolution, a modified sample image set; generating, by padding or cropping a respective sample text sequence in the sample text sequence set to a predetermined text length, a modified sample text sequence set; and updating a parameter value of the image generation model based on a sample image and a sample text sequence that match each other in the generated modified sample image set and the modified sample text sequence set.

In some embodiments, the training of the image generation model includes a second training stage, and the second training stage includes: dividing respective sample images in the sample image set into a plurality of sample image subsets based on respective resolutions, where each sample image subset is associated with a corresponding resolution; generating, by padding or cropping a respective sample text sequence in the sample text sequence set to a predetermined text length, a modified sample text sequence set; and training a parameter value of the image generation model based on the plurality of sample image subsets and the modified sample text sequence set.

In some embodiments, training the parameter value of the image generation model based on the plurality of sample image subsets and the modified sample text sequence set includes: in each of a plurality of training batches in the second training stage, updating the parameter value of the image generation model based on one of the plurality of sample image subsets and a sample text sequence subset matching the one sample image subset in the modified sample text sequence set.

In some embodiments, the training of the image generation model includes a third training stage, and the third training stage includes: updating the parameter value of the image generation model based on a sample image and a sample text sequence that match each other in the plurality of sample image subsets and the sample text sequence set.

In some embodiments, updating the parameter value of the image generation model based on the sample image and the sample text sequence that match each other in the plurality of sample image subsets and the sample text sequence set includes: in each of a plurality of training batches in the third training stage, updating the parameter value of the image generation model based on one of the plurality of sample image subsets and a sample text sequence subset matching the one sample image subset in the sample text sequence set.

FIG. 7 is a block diagram of an apparatus 700 for image generation according to some embodiments of the present disclosure. The apparatus 700 may be implemented or included at the electronic device 110 in FIG. 1. The individual modules/components in the apparatus 700 may be implemented by hardware, software, firmware, or any combination thereof.

As shown in the figure, the apparatus 700 includes a text receiving module 710 configured to receive a text sequence indicating condition information of image generation; a text inputting module 720 configured to input the text sequence into a trained image generation model; and an image generating module 730 configured to generate, through the image generation model, a target image matching the condition information based on at least the text sequence. The target resolution of the target image is determined based on the text sequence. The image generation model is obtained through training based on a sample image set and a sample text sequence set. A sample image in the sample image set matches a sample text sequence in the sample text sequence set. Sample images in the sample image set have different resolutions, and sample text sequences have different text lengths.

In some embodiments, the text sequence is input into the trained image generation model, without transforming the text sequence to a predetermined text length.

In some embodiments, the text sequence further indicates the target resolution to be generated, and the image generating module 730 is configured to: determine, through the image generation model, the target resolution from the text sequence; and generate, through the image generation model, the target image according to the determined target resolution.

In some embodiments, the training of the image generation model includes a first training stage, and the first training stage includes: generating, by transforming a respective sample image in the sample image set to a predetermined resolution, a modified sample image set; generating, by padding or cropping a respective sample text sequence in the sample text sequence set to a predetermined text length, a modified sample text sequence set; and updating a parameter value of the image generation model based on a sample image and a sample text sequence that match each other in the generated modified sample image set and the modified sample text sequence set.

In some embodiments, the training of the image generation model includes a second training stage, and the second training stage includes: dividing respective sample images in the sample image set into a plurality of sample image subsets based on respective resolutions, where each sample image subset is associated with a corresponding resolution; generating, by padding or cropping a respective sample text sequence in the sample text sequence set to a predetermined text length, a modified sample text sequence set; and training a parameter value of the image generation model based on the plurality of sample image subsets and the modified sample text sequence set.

In some embodiments, training the parameter value of the image generation model based on the plurality of sample image subsets and the modified sample text sequence set includes: in each of a plurality of training batches in the second training stage, updating the parameter value of the image generation model based on one of the plurality of sample image subsets and a sample text sequence subset matching the one sample image subset in the modified sample text sequence set.

In some embodiments, the training of the image generation model includes a third training stage, and the third training stage includes: updating the parameter value of the image generation model based on a sample image and a sample text sequence that match each other in the plurality of sample image subsets and the sample text sequence set.

In some embodiments, updating the parameter value of the image generation model based on the sample image and the sample text sequence that match each other in the plurality of sample image subsets and the sample text sequence set includes: in each of a plurality of training batches in the third training stage, updating the parameter value of the image generation model based on one of the plurality of sample image subsets and a sample text sequence subset matching the one sample image subset in the sample text sequence set.

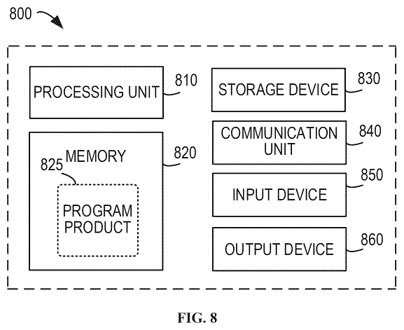

FIG. 8 is a block diagram of an electronic device 800 in which one or more embodiments of the present disclosure can be implemented. It should be understood that the electronic device 800 shown in FIG. 8 is only example and should not constitute any limitation to the function and scope of the embodiments described herein. The electronic device 800 shown in FIG. 8 may be used to implement the electronic device 110 in FIG. 1 or the apparatus 700 in FIG. 7.

As shown in FIG. 8, the electronic device 800 is in the form of a general computing device.

Components of the electronic device 800 may include, but are not limited to, one or more processors or processing units 810, a memory 820, a storage device 830, one or more communication units 840, one or more input devices 850, and one or more output devices 860. The processing unit 810 may be a physical or virtual processor and may perform various processes according to a program stored in the memory 820. In a multi-processor system, multiple processing units execute computer-executable instructions in parallel to improve the parallel processing capability of the electronic device 800.

The electronic device 800 generally includes multiple computer storage media. Such media may be any available media accessible by the electronic device 800, including but not limited to volatile and non-volatile media, and detachable and non-detachable media. The memory 820 may be a volatile memory (for example, a register, a cache, a random access memory (RAM)), a non-volatile memory (for example, a read-only memory (ROM), an electrically erasable programmable read-only memory (EEPROM), a flash memory), or a certain combination thereof. The storage device 830 may be a detachable or non-detachable medium, and may include a machine-readable medium, such as a flash drive, a magnetic disk, or any other medium, which may be capable of storing information and/or data and accessible within the electronic device 800.

The electronic device 800 may further include another detachable/non-detachable, volatile/non-volatile storage medium. Although not shown in FIG. 8, a disk drive for reading from or writing to a detachable, non-volatile disk (for example, a “floppy disk”) and an optical disk drive for reading from or writing to a detachable, non-volatile optical disk may be provided. In these cases, each drive may be connected to a bus (not shown) through one or more data medium interfaces. The memory 820 may include a computer program product 825 having one or more program modules, and the program modules are configured to perform various methods or actions of various embodiments of the present disclosure.

The communication unit 840 communicates with other electronic devices through a communication medium. In addition, the functions of the components of the electronic device 800 may be implemented by a single computing cluster or multiple computing machines, and these computing machines may communicate through a communication connection. Therefore, the electronic device 800 may operate in a networked environment using a logical connection with one or more other servers, network personal computers (PCs), or another network node.

The input device 850 may be one or more input devices, such as a mouse, a keyboard, a trackball, or the like. The output device 860 may be one or more output devices, such as a display, a speaker, a printer, or the like. The electronic device 800 may also communicate with one or more external devices (not shown) such as a storage device, a display device, or the like, one or more devices that enable the user to interact with the electronic device 800, or any device (for example, a network card, a modem, or the like) that enables the electronic device 800 to communicate with one or more other electronic devices, through the communication unit 840 as required. Such communication may be performed through an input/output (I/O) interface (not shown).

According to an example implementation of the present disclosure, a computer-readable storage medium is provided, on which computer-executable instructions are stored, where the computer-executable instructions are executed by a processor to implement the method described above. According to an example implementation of the present disclosure, a computer program product is further provided. The computer program product is physically stored on a non-transitory computer-readable medium and includes computer-executable instructions, and the computer-executable instructions are executed by a processor to implement the method described above.

Various aspects of the present disclosure are described herein with reference to the flowcharts and/or block diagrams of the method, apparatus, device, and computer program product implemented according to the present disclosure. It should be understood that each block of the flowcharts and/or block diagrams and combinations of blocks in the flowcharts and/or block diagrams may be implemented by computer-readable program instructions.

These computer-readable program instructions may be provided to the processing unit of the general-purpose computer, the special-purpose computer, or the other programmable data processing apparatus, thereby producing a machine, so that these instructions, when executed by the processing unit of the computer or the other programmable data processing apparatus, produce the apparatus that performs the functions/actions specified in one or more blocks in the flowcharts and/or block diagrams. These computer-readable program instructions may also be stored in the computer-readable storage medium. These instructions cause the computer, the programmable data processing apparatus, and/or the other device to work in a specific way. Therefore, the computer-readable medium storing the instructions includes a product, which includes instructions for implementing various aspects of the functions/actions specified in one or more blocks in the flowcharts and/or block diagrams.

The computer-readable program instructions may be loaded onto the computer, another programmable data processing apparatus, or another device, so that a series of operational steps are performed on the computer, another programmable data processing apparatus, or another device, to generate a computer-implemented process. Therefore, the instructions that are executed on the computer, another programmable data processing apparatus, or another device implement the functions/actions specified in one or more blocks in the flowcharts and/or block diagrams.

The flowcharts and block diagrams in the drawings show possible architectures, functions, and operations of the system, method, and computer program product implemented according to the present disclosure. In this regard, each block in the flowcharts or block diagrams may represent a module, a program segment, or a part of instructions. The module, the program segment, or the part of the instructions includes one or more executable instructions for implementing specified logical functions. In some alternative implementations, the functions marked in the blocks may occur in an order different from the order marked in the drawings. For example, two consecutive blocks may actually be performed substantially in parallel, or sometimes may be performed in a reverse order, depending on the functions involved. It should also be noted that each block in the block diagrams and/or flowcharts and combinations of blocks in the block diagrams and/or flowcharts may be implemented by a dedicated hardware-based system that performs specified functions or actions, or may be implemented by a combination of dedicated hardware and computer instructions.

Various implementations of the present disclosure have been described above, and the foregoing description is example and non-exhaustive, and is not limited to the disclosed implementations. Many modifications and changes are obvious to those of ordinary skill in the art without departing from the scope and spirit of the described implementations. The selection of terms used in this specification is intended to best explain the principles, practical applications, or improvements of the technologies in the market of the implementations, or to enable other ordinary skill in the art to understand the implementations disclosed herein.

1. A method of image generation, comprising:
receiving a text sequence indicating condition information of image generation;
inputting the text sequence into a trained image generation model; and
generating, through the image generation model, a target image matching the condition information based on at least the text sequence, wherein a target resolution of the target image is determined based on the text sequence,
wherein the image generation model is obtained through training based on a sample image set and a sample text sequence set, a sample image in the sample image set matches a sample text sequence in the sample text sequence set, sample images in the sample image set have different resolutions, and sample text sequences have different text lengths.

2. The method according to claim 1, wherein the text sequence is input into the trained image generation model, without transforming the text sequence to a predetermined text length.

3. The method according to claim 1, wherein the text sequence further indicates the target resolution to be generated, and wherein generating, through the image generation model, the target image matching the condition information based on at least the text sequence comprises:
determining, with the image generation model, the target resolution from the text sequence; and
generating, with the image generation model, the target image according to the determined target resolution.

4. The method according to claim 1, wherein training of the image generation model comprises a first training stage, and the first training stage comprises:
generating a modified sample image set by transforming a respective sample image in the sample image set to a predetermined resolution;
generating a modified sample text sequence set by padding or cropping a respective sample text sequence in the sample text sequence set to a predetermined text length; and
updating a parameter value of the image generation model based on a sample image and a sample text sequence that match each other in the generated modified sample image set and the modified sample text sequence set.

5. The method according to claim 1, wherein training of the image generation model comprises a second training stage, and the second training stage comprises:
dividing respective sample images in the sample image set into a plurality of sample image subsets based on respective resolutions, wherein each sample image subset is associated with a corresponding resolution;
generating a modified sample text sequence set by padding or cropping a respective sample text sequence in the sample text sequence set to a predetermined text length; and
training a parameter value of the image generation model based on the plurality of sample image subsets and the modified sample text sequence set.

6. The method according to claim 5, wherein training the parameter value of the image generation model based on the plurality of sample image subsets and the modified sample text sequence set comprises:
in each of a plurality of training batches in the second training stage, updating the parameter value of the image generation model based on one of the plurality of sample image subsets and a sample text sequence subset matching the one sample image subset in the modified sample text sequence set.

7. The method according to claim 5, wherein training of the image generation model comprises a third training stage, and the third training stage comprises:
updating the parameter value of the image generation model based on a sample image and a sample text sequence that match each other in the plurality of sample image subsets and the sample text sequence set.

8. The method according to claim 7, wherein updating the parameter value of the image generation model based on the sample image and the sample text sequence that match each other in the plurality of sample image subsets and the sample text sequence set comprises:
in each of a plurality of training batches in the third training stage, updating the parameter value of the image generation model based on one of the plurality of sample image subsets and a sample text sequence subset matching the one sample image subset in the sample text sequence set.

9. An electronic device, comprising:
at least one processing unit; and
at least one memory coupled to the at least one processing unit and storing instructions executable by the at least one processing unit, wherein the instructions, when executed by the at least one processing unit, cause the device to perform acts comprising:
receiving a text sequence indicating condition information of image generation;
inputting the text sequence into a trained image generation model; and
generating, through the image generation model, a target image matching the condition information based on at least the text sequence, wherein a target resolution of the target image is determined based on the text sequence,
wherein the image generation model is obtained through training based on a sample image set and a sample text sequence set, a sample image in the sample image set matches a sample text sequence in the sample text sequence set, sample images in the sample image set have different resolutions, and sample text sequences have different text lengths.

10. The device according to claim 9, wherein the text sequence is input into the trained image generation model, without transforming the text sequence to a predetermined text length.

11. The device according to claim 9, wherein the text sequence further indicates the target resolution to be generated, and wherein generating, through the image generation model, the target image matching the condition information based on at least the text sequence comprises:
determining, with the image generation model, the target resolution from the text sequence; and
generating, with the image generation model, the target image according to the determined target resolution.

12. The device according to claim 9, wherein training of the image generation model comprises a first training stage, and the first training stage comprises:
generating a modified sample image set by transforming a respective sample image in the sample image set to a predetermined resolution;
generating a modified sample text sequence set by padding or cropping a respective sample text sequence in the sample text sequence set to a predetermined text length; and
updating a parameter value of the image generation model based on a sample image and a sample text sequence that match each other in the generated modified sample image set and the modified sample text sequence set.

13. The device according to claim 9, wherein training of the image generation model comprises a second training stage, and the second training stage comprises:
dividing respective sample images in the sample image set into a plurality of sample image subsets based on respective resolutions, wherein each sample image subset is associated with a corresponding resolution;
generating a modified sample text sequence set by padding or cropping a respective sample text sequence in the sample text sequence set to a predetermined text length; and
training a parameter value of the image generation model based on the plurality of sample image subsets and the modified sample text sequence set.

14. The device according to claim 13, wherein training the parameter value of the image generation model based on the plurality of sample image subsets and the modified sample text sequence set comprises:
in each of a plurality of training batches in the second training stage, updating the parameter value of the image generation model based on one of the plurality of sample image subsets and a sample text sequence subset matching the one sample image subset in the modified sample text sequence set.

15. The device according to claim 13, wherein training of the image generation model comprises a third training stage, and the third training stage comprises:
updating the parameter value of the image generation model based on a sample image and a sample text sequence that match each other in the plurality of sample image subsets and the sample text sequence set.

16. The device according to claim 15, wherein updating the parameter value of the image generation model based on the sample image and the sample text sequence that match each other in the plurality of sample image subsets and the sample text sequence set comprises:
in each of a plurality of training batches in the third training stage, updating the parameter value of the image generation model based on one of the plurality of sample image subsets and a sample text sequence subset matching the one sample image subset in the sample text sequence set.

17. A non-transitory computer-readable storage medium storing a computer program that, when executed by a processor, performs acts comprising:
receiving a text sequence indicating condition information of image generation;
inputting the text sequence into a trained image generation model; and
generating, through the image generation model, a target image matching the condition information based on at least the text sequence, wherein a target resolution of the target image is determined based on the text sequence,
wherein the image generation model is obtained through training based on a sample image set and a sample text sequence set, a sample image in the sample image set matches a sample text sequence in the sample text sequence set, sample images in the sample image set have different resolutions, and sample text sequences have different text lengths.

18. The non-transitory computer-readable storage medium according to claim 17, wherein the text sequence is input into the trained image generation model, without transforming the text sequence to a predetermined text length.

19. The non-transitory computer-readable storage medium according to claim 17, wherein the text sequence further indicates the target resolution to be generated, and wherein generating, through the image generation model, the target image matching the condition information based on at least the text sequence comprises:
determining, with the image generation model, the target resolution from the text sequence; and
generating, with the image generation model, the target image according to the determined target resolution.

20. The non-transitory computer-readable storage medium according to claim 17, wherein training of the image generation model comprises a first training stage, and the first training stage comprises:
generating a modified sample image set by transforming a respective sample image in the sample image set to a predetermined resolution;
generating a modified sample text sequence set by padding or cropping a respective sample text sequence in the sample text sequence set to a predetermined text length; and
updating a parameter value of the image generation model based on a sample image and a sample text sequence that match each other in the generated modified sample image set and the modified sample text sequence set.
